(19) United States
(12) Patent Application Publication
(10) Pub. No.: US 2020/0233632 A1
(43) Pub. Date: Jul. 23, 2020

(54) Analogue-Digital Converter

(71) Applicant: Logan Tyler Smith, Seattle, WA (US)

(72) Inventor: Logan Tyler Smith, Seattle, WA (US)

(21) Appl. No.: 16/457,108

(22) Filed: Jun. 28, 2019

Related U.S. Application Data
(60) Provisional application No. 62/795,505, filed on Jan. 22, 2019.

(51) Int. Cl. G06F 3/16; H04B 1/3827; H04W 76/10; H04R 1/10; G10L 19/00

(52) U.S. Cl. CPC G06F 3/162; H04B 1/3827; H04R 2420/07; H04R 1/1041; G10L 19/00; H04W 76/10

(57) ABSTRACT

An audio-interface miniaturized into an audio interface device has been provided. The audio interface device includes an audio connector. Further, the audio interface device houses a circuit board assembly including necessary electronics to perform analog-to-digital conversion, and vice-versa. For example, the circuit board assembly may include at least an analogue preamplifier, an audio codec, one or more connectors, an audio controller, a Universal Serial Bus (USB) interface, and an USB connector. The circuit board assembly may be housed inside a body of the audio interface device.

### CROSS-REFERENCE TO RELATED PATENT DOCUMENTS

This patent application claims the benefit of priority of U.S. Provisional Application No. 62/795,505, entitled “Improved Analogue-Digital Converter,” filed Jan. 22, 2019, which are hereby incorporated herein by reference in its entirety.

### FIELD OF THE INVENTION

The present disclosure relates to the field of integrated circuits, and more particularly, to an audio interface miniaturized into an audio connector.

### BACKGROUND

In today's music world, the generation, transmission, amplification, and control of audio and other media signals and devices involve diverse yet interrelated technologies that are changing rapidly. The problem of the existing audio hardware market is in its application of technologies. Musicians can connect their music instruments (such as guitar) to their computing devices (such as laptops, smartphones, or the like) for playing, recording, and processing the audio and media signals via digital-to-analog and analog-to-digital converters (audio interfaces), that serve as an intermediary between the analog signal produced by the instrument or microphone and the digital recording device. In earlier technologies, the audio interface is a separate device that must be connected via cables to other devices in the system. As such, the most basic systems require at least an instrument, a first cable to the audio interface, the audio interface itself, a second cable connecting the digital recorder, and the digital recorder itself, or five components in total. As the system size grows, the total component count multiplies.

Another basic yet important part of the problem is that a single cable that is simple to install and use would reduce a muscician' s burden in procuring and assembling an audio interface system. Thus, it would be desirable to have a miniaturized audio interface that acts as an audio interface between the computers and music instruments.

Many of the existing systems are difficult to install, lack flexible reconfiguration capabilities, and do not take advantage of intuitive user-friendly hardware and software interfaces. Existing interconnection specifications do not satisfy the unique requirements of audio performances, particularly in the areas of clocking, distance synchronization, and jitter or latency management. Thus, there remains a compelling need in the audio industry for an open architecture digital interconnect that would allow audio products (such as musical instruments, processors, amplifiers, recording and mixing devices, etc.), to seamlessly communicate.

### SUMMARY

In an embodiment of the present disclosure, an audio-interface miniaturized into an audio connector has been provided. By using the audio interface device, a need for a separate box between an instrument and a device is eliminated. Instead, one wire can interface between the two devices. The audio interface device includes an audio connector such as a ¼ inch phone plug or a 3-pin XLR receptacle. Further, the audio interface device houses a circuit board assembly including necessary electronics to perform analog-to-digital conversion, and vice-versa. For example, the circuit board assembly may include at least an analogue preamplifier, an audio codec, one or more connectors, an audio controller, a Universal Serial Bus (USB) interface, and an USB connector. The circuit board assembly may be housed inside a body of the audio interface device.

In an embodiment, the circuit board is the most complex aspect, and fundamentally performs the following three things:
Convert incoming audio signals on the audio jack or plug, into digital signals
Convert incoming digital signals to the 3.5 mm headset, into analog signals
Interface with a host device through the use of an USB cable, or wireless transceiver.

### BRIEF DESCRIPTION OF THE DRAWINGS

The following detailed description of the preferred embodiments of the present disclosure will be better understood when read in conjunction with the appended drawings.

The present disclosure is illustrated by way of example, and not limited by the accompanying figures, in which like references indicate similar elements.

FIG. 1 is a schematic block diagram of an audio interface device, in accordance with an embodiment of the present disclosure;

FIG. 2 is a schematic block diagram of the audio interface device, in accordance with another embodiment of the present disclosure;

FIG. 3 is a schematic block diagram of the audio interface device, in accordance with another embodiment of the present disclosure;

FIG. 4 is a schematic block diagram of the audio interface device in communication with an wireless adapter, in accordance with an embodiment of the present disclosure;

FIG. 5 is a schematic block diagram of communication between the audio interface device and a host device without wireless capability, in accordance with an embodiment of the present disclosure;

FIG. 6 is a schematic block diagram of communication between the audio interface device and a host device with wireless capability, in accordance with an embodiment of the present disclosure;

FIGS. 7A-7D are diagrams that illustrate various views of a body of the audio interface device, in accordance with an embodiment of the present disclosure;

FIG. 8 is a diagram that illustrates the audio interface device, in accordance with an embodiment of the present disclosure; and

FIG. 9 is a diagram that illustrates various components inside the audio interface device, in accordance with an embodiment of the present disclosure.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components which constitutes an audio interface device miniaturized into an audio connector. Accordingly, the components and the method steps have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

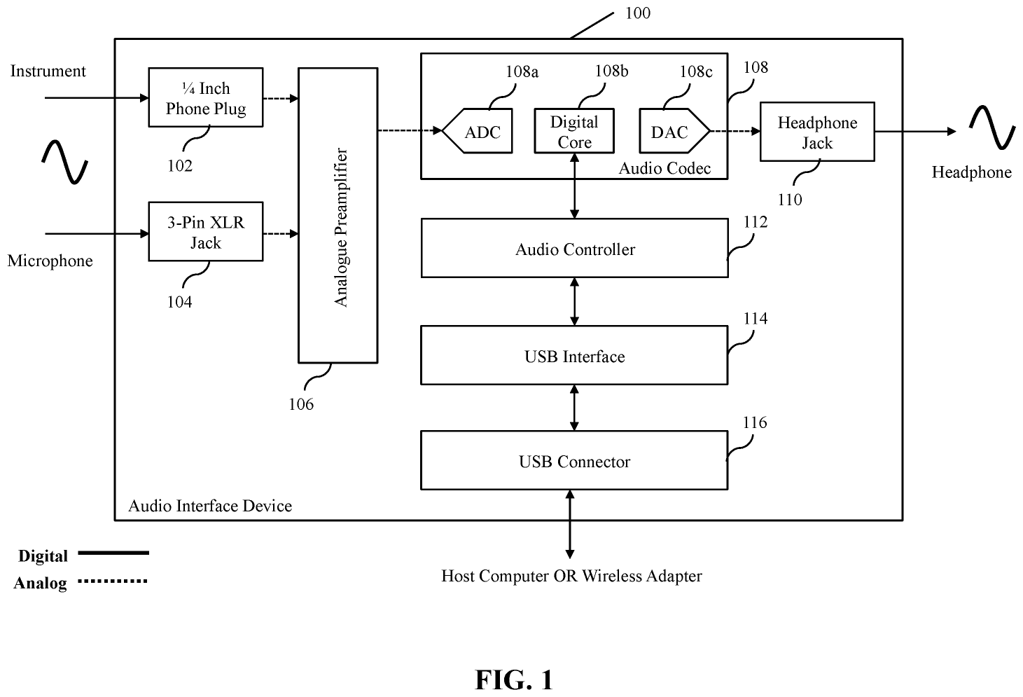

Referring now to FIG. 1, a schematic block diagram of an audio interface device 100 is shown, in accordance with an embodiment of the present disclosure. The audio interface device 100 is an electrical or optical connector for carrying audio signals. The audio interface device 100 defines physical parameters and interpretation of the audio signals. For digital audio, this can be thought of as defining the physical layer, data link layer, and most or all of the application layer. For analog audio, these functions are all represented in a single signal specification to the direct speaker-driving signal of analog audio. Physical characteristics of the electrical or optical equipment includes the types and numbers of wires required, voltages, frequencies, optical intensity, and the physical design of the connectors.

The audio interface device 100 includes circuitry such as a first connector 102 and/or a second connector 104, an analogue preamplifier 106, an audio codec 108, a third connector 110, an audio controller 112, a Universal Serial Bus (USB) interface 114, and a USB controller 116. The audio codec 108 includes circuitry such as an analog-to-digital converter (ADC) 108a, a digital core 108b, and a digital-to-analog converter (DAC) 108c.

The first connector 102 is an electrical connector that is used for receiving analog audio signals from one or more instruments. The first connector 102 is commonly known as a phone jack, an audio jack, a headphone jack, or a jack plug. In the context of the present disclosure, a ¼ inch phone plug has been used as the first connector 102. The first connector 102 is used for connecting an instrument. The first connector 102 is inserted into an instrument jack of the instrument for receiving an analog audio signal produced by the instrument.

The second connector 104 is an electrical connector that is used for receiving analog audio signals from one or more microphones. The second connector 104 is commonly known as an XLR jack or an XLR connector. The second connector 104 is circular in design and has three to seven pins. In the context of the present disclosure, a 3-pin XLR jack has been used as the second connector 104. The second connector 104 is used for connecting a microphone for receiving an analog audio signal produced by the microphone.

The analogue preamplifier 106 is an electronic amplifier that amplifies or attenuates the amplitude of electrical signal (such as an audio signal), which may be beneficial or necessary for further processing. Signal amplification increases the noise tolerance of the processed signal if the signal is initially weak, while attenuation is beneficial to prevent clipping or damage to other electronic components if the signal is excessively strong. The analogue preamplifier 106 may be linear (i.e., may have a constant gain through its operating range). Further, the analogue preamplifier 106 may have high input impedance and a low output impedance, and resultant passive filtering, such as high-pass or low-pass signal. The analogue preamplifier 106 may be used to boost the signal strength to drive the cable to the main instrument without significantly degrading the signal-to-noise ratio (SNR). The analogue preamplifier 106 is typically used to amplify signals from analog sensors such as microphones, music instruments, or the like. The analogue preamplifier 106 may be connected to at least one of the first connector 102 or the second connector 104 for receiving the analog audio signal. The analog audio signal may be produced by a sound source such as the instrument or the microphone. Based on the received analog audio signal, the analogue preamplifier 106 generates an amplified audio signal.

The audio codec 108 is a digital electronic device, electronic signal processing, or a combination thereof that aids in the compression and decompression of an audio data stream. A software-based audio codec essentially consists of an implemented algorithm that codes and decodes an audio stream. A hardware-based audio codec is primarily for analog audio data to be encoded or decoded. The audio codec 108 encodes analog audio (such as the amplified audio signal generated by the analogue preamplifier 106) as digital audio signals and decodes the digital audio signals back into analog. For example, the ADC 108a receives the amplified audio signal from the analogue preamplifier 106 and converts the amplified audio signal into the digital signals. Similarly, the DAC 108c receives the digital signals from the ADC 108a and converts the digital signals back to the analog signals. The encoding and decoding of the signals are performed using the digital core 108b. The digital core 108b may include one or more signal processing functions such as filtering, gain control, or equalization, that are executed by the ADC 108a or the DAC 108c for performing the encoding and decoding of the respective signals.

The third connector 110 is an electrical connector that is used for receiving the analog audio signals from the DAC 108c. The third connector 110 is commonly known as a phone jack, an audio jack, a headphone jack, or a jack plug. In the context of the present disclosure, a headphone jack has been used as the third connector 110. The third connector 110 is used for connecting an output device (such as a headphone) by using a cable. One end of the cable is connected to the headphone and other end is plugged into the third connector 110 for receiving the analog audio signal.

The audio controller 112 may include suitable logic, circuitry, interfaces, and/or code, executable by the circuitry, that may be configured to perform one or more audio-related control operations. The audio controller 122 may be configured to control an input level and an output level of the audio signals. The audio controller 112 may be used to perform digital signal processing on digitized audio signals. For example, the audio controller 112 may receive the digital audio signals from the ADC 108a. The audio controller 112 may employ gain control, a noise-gate, or other signal processing. Similarly, the audio controller 112 may send the analog audio signals to the DAC 108c. The DAC 108c may process the digital audio signals to return the analog audio signals for use in powering, for example, a headphone or a standard electric guitar amplifier. The DAC 108c may be used to transform the digital audio signals to the analog audio signals. The DAC 108c may then process the analog audio signals that may be optimized for powering, for example, a headphone or a standard electric guitar amplifier to optimize a high quality, low distortion signal for hearing by a user. In an embodiment, the device may include a secondary headphone amplifier that amplifies the signal sent from the CODEC. The audio controller 112 may be implemented by one or more processors, such as, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the processor may be compatible with multiple operating systems.

The USB interface 114 may include suitable logic, circuitry, interfaces, and/or code, executable by the circuitry, that may be configured to perform one or more operations. The USB interface 114 may be used for connecting two or more electronic devices together. For example, the USB interface 114 may be used for connecting the audio interface device 100 with a host computer or a wireless device by means of the USB connector 116. In an exemplary embodiment of the present disclosure, the USB interface 114 is connected to the audio controller 112 and the USB connector 116. The USB interface 114 provides various benefits, including plug-and-play, increased data transfer rate (DTR), high polling rates and attendant reduction in Round-Trip-Latency (RTL), reduced number of connectors, and addressing usability issues with existing interfaces. There are several versions of USB connectors, which vary in their DTRs and polling rates: USB 1.0 with DTR of 1.5 Mbps and 12 Mbps, USB 2.0 with DTR of 480 Mbps, and USB 3.0, or SuperSpeed, with DTR up to 5 Gbps. USB 2.0 FS operates at a 1 kHz polling rate, while USB 2.0 High-Speed mode offers a polling rate of 8 Hz. 1 kHz polling was determined to provide unnacceptably high latency, thus USB 2.0 HS is required for the application.

The USB connector 116 is a connector that is used for connecting the audio interface device 100 with a peripheral device such as an electronic device such as a computer or a smartphone. The USB connector 116 is part of the USB interface 114, which includes various types of ports, cables, and connectors.

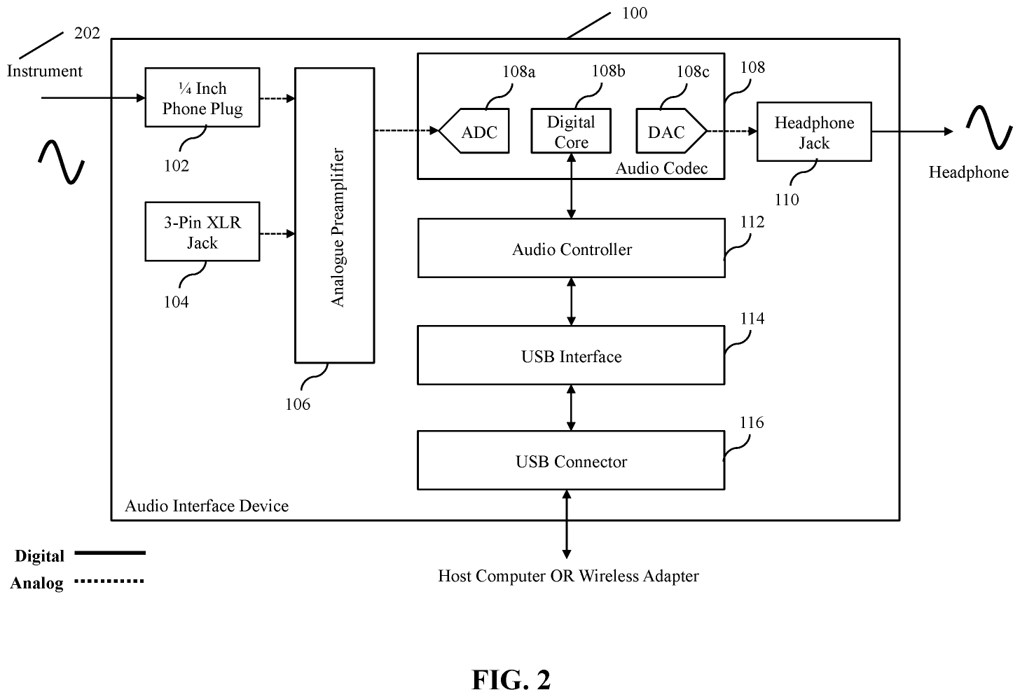

FIG. 2 is a schematic block diagram of the audio interface device 100, in accordance with another embodiment of the present disclosure. As shown in FIG. 2, the audio interface device 100 is connected to an instrument 202 (such as an electric guitar) via the first connector 102 (i.e., the ¼ inch phone plug). The analogue preamplifier 106 receives the analog audio signals produced by the instrument 202, and generates an amplified audio signals. The audio codec 108 converts the analog audio signals (i.e., the amplified audio signals) into the digital audio signals and the digital audio signals into the analog format under the control of the audio controller 112. The audio codec 108 generates an analog audio output signal that is communicated to a user via a headphone.

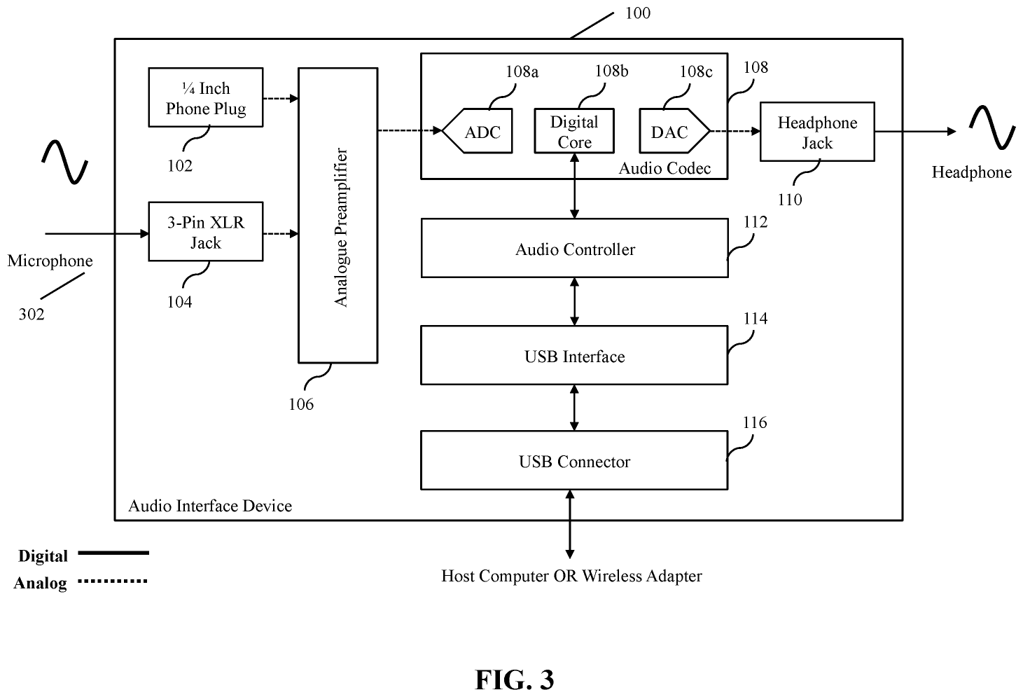

FIG. 3 is a schematic block diagram of the audio interface device 100, in accordance with another embodiment of the present disclosure. As shown in FIG. 3, the audio interface device 100 is connected to a microphone 302 via the second connector 104 (i.e., the 3-pin XLR jack). The analogue preamplifier 106 receives the analog audio signals produced by the microphone 302, and generates an amplified audio signals. The audio codec 108 converts the analog audio signals (i.e., the amplified audio signals) into the digital audio signals and the digital audio signals into the analog format under the control of the audio controller 112. The audio codec 108 generates an analog audio output signal that is communicated to a user via a headphone.

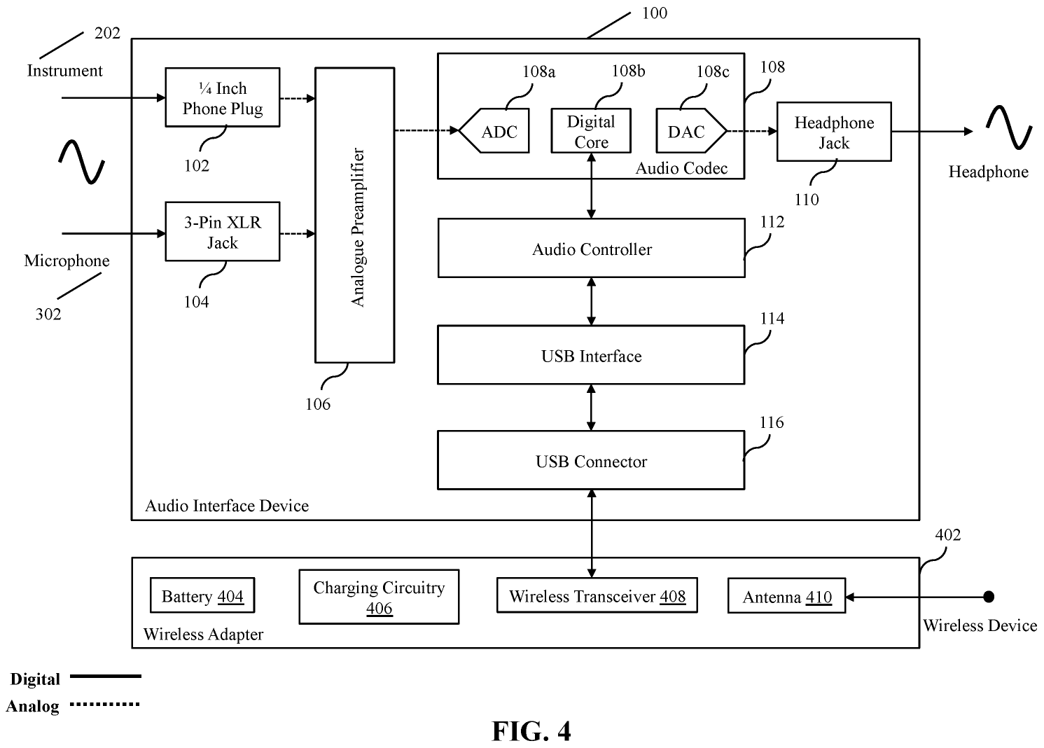

FIG. 4 is a schematic block diagram of the audio interface device 100 in communication with an wireless adapter 402, in accordance with an embodiment of the present disclosure. The wireless adapter 402 is an electronic device that is generally attached to a computer or other workstation device to allow it to connect to a wireless system. The wireless adapter 402 may be available in an USB stick form that is plugged into a USB port such as the USB connector 116. The wireless adapter 402 may also be available in the form of PCI network cards that plug into a PCI slot on the computer motherboard. They do not generally plug into the Ethernet port. Instead, an Ethernet cable can connect a computer directly to a router or other device.

The wireless adapter 402 includes circuitry such as a battery 404, a charging circuitry 406, a wireless transceiver 408, and an antenna 410. The battery 402 is used to power the wireless adapter 402. Power may be consumed from the battery 402 when the wireless adapter 402 is in a transceiving mode, for example, via the wireless transceiver 408. When coupled to a host system, the wireless adapter 402 may receive power from the host and the battery 402 may not be used. The battery 402 may be charged by using the charging circuitry 406 of the wireless adapter 402. In another example, the battery 402 may be charged while coupled to a host directly or via an intermediary system such as another wireless adapter. In an embodiment, only the antenna 410 or some other part of the wireless transceiver 408 is exposed for connecting another device or system.

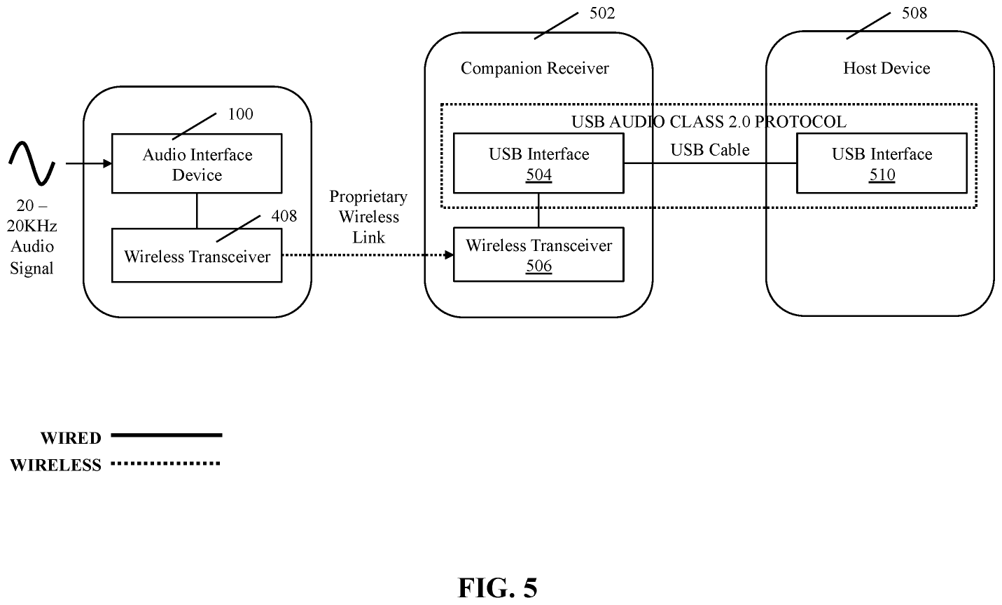

FIG. 5 is a schematic block diagram of communication between the audio interface device 100 and a host device 508 without wireless capability, in accordance with an embodiment of the present disclosure. The audio interface device 100 is connected to the wireless transceiver 408 of the wireless adapter 402. The wireless transceiver 408 is wirelessly connected to a wireless transceiver 506 of a companion receiver 502, thereby establishing the wireless communication between the audio interface device 100 and the companion receiver 502. An USB interface 510 of the host device 508 is further connected to an USB interface 504 of the companion receiver 502 by means of an USB cable, thereby establishing the communication between the audio interface device 100 and the host device 508. Such wireless system architecture (as shown in FIG. 5) exhibits lowest latency and highest reliability. Further, the host device 508 does not need the wireless capability for communicating with the audio interface device 100.

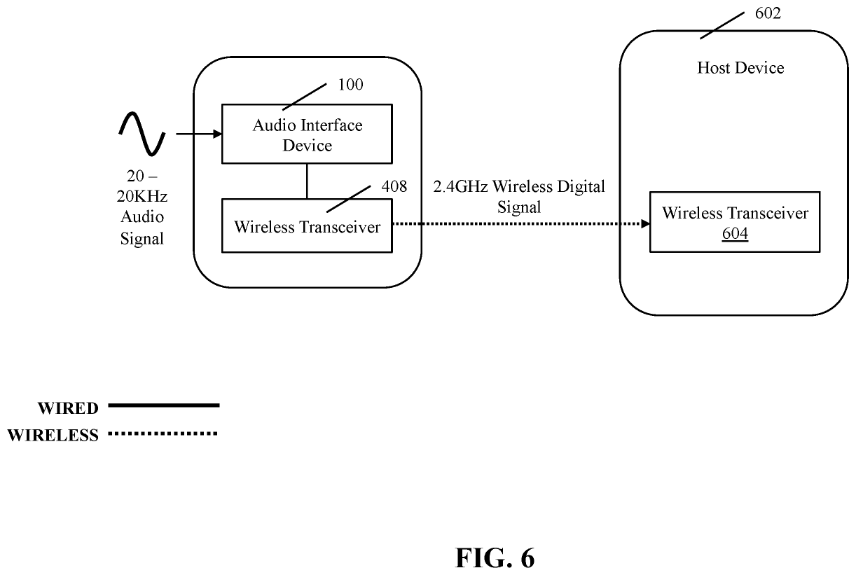

FIG. 6 is a schematic block diagram of communication between the audio interface device 100 and a host device 602 with wireless capability, in accordance with an embodiment of the present disclosure. The host device 602 may include a wireless transceiver 604 that is wireless connected to the wireless transceiver 408, thereby establishing the communication between the audio interface device 100 and the host device 602. Such wireless system architecture (as shown in FIG. 6) exhibits lowest latency. Further, the host device 602 does not need a separate receiver module (such as the companion receiver 502) for establishing the communication with the audio interface device 100.

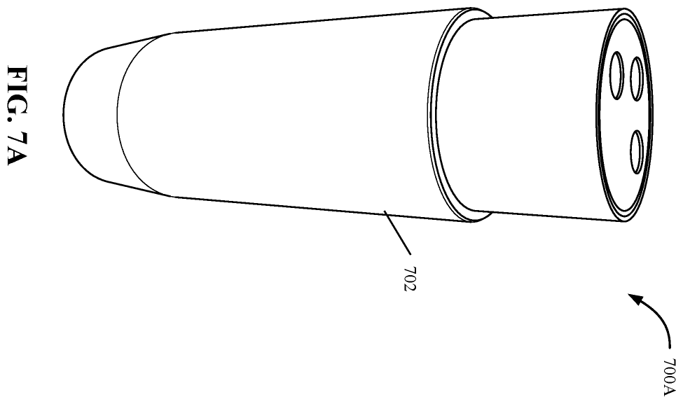

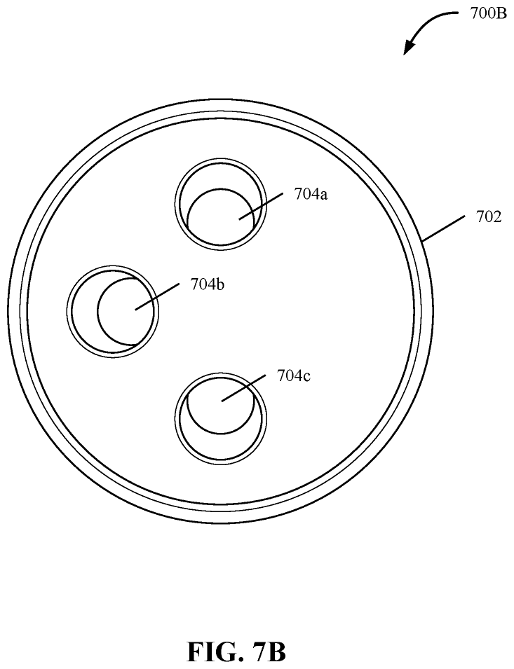

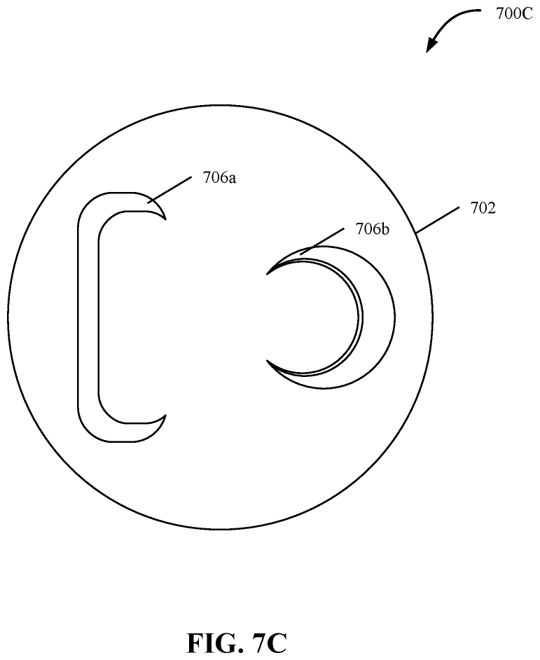

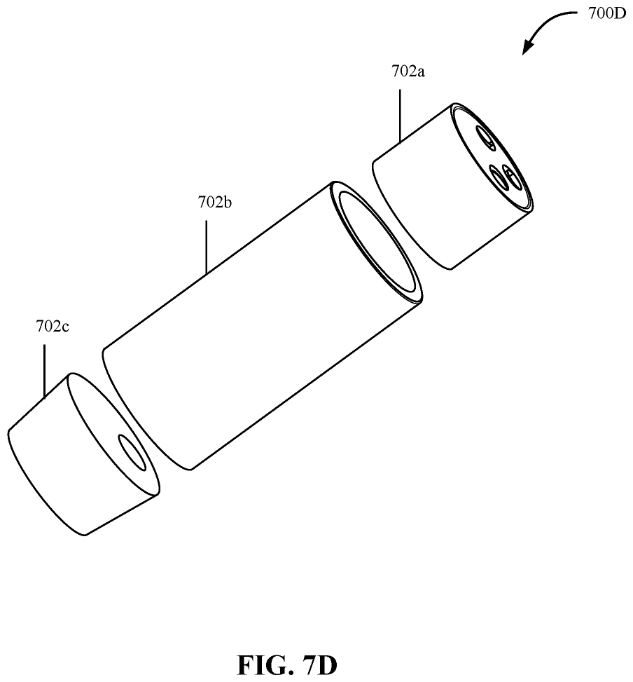

FIGS. 7A-7D are diagrams that illustrate various views of a body of the audio interface device 100, in accordance with an embodiment of the present disclosure. FIG. 7A illustrates a top isometric view 700A of the body 702 of the audio interface device 100. The body 702 is a cylindrical body. FIG. 7B illustrates a top view 700B of the body 702 of the audio interface device 100. The top view 700B illustrates 3 slots (such as slots 704a-704c) that are used for removably attaching the 3-pin XLR jack for connecting the microphone 302. FIG. 7C illustrates a bottom view 700C of the body 702 of the audio interface device 100. The bottom view illustrates 2 slots (such as slots 706a and 706b). The slot 706a corresponds to the USB connector 116. The slot 706b corresponds to the third connector 110 (i.e., the integrated headphone jack). FIG. 7D illustrates a blown-up view 700D of the body 702 of the audio interface device 100. The blown-up view 700D of the body 702 illustrates a top body portion 702a, a middle body portion 702b, and a bottom body portion 702c. The top body portion 702a may house the slots 704a-704c. The middle body portion 702b may house a printed circuit board (PCB) including the various circuitry and components of the audio interface device 100. The bottom body portion 702c may house the slots 706a and 706b.

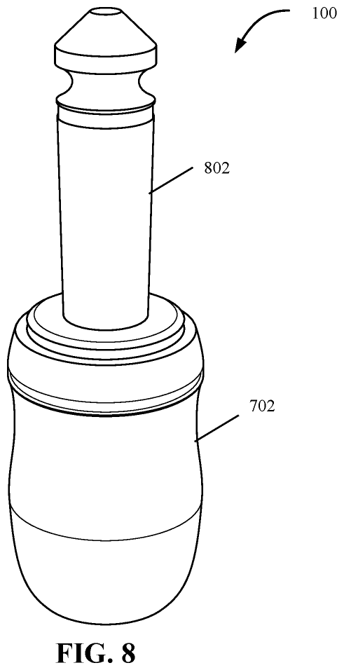

FIG. 8 is a diagram that illustrates the audio interface device 100, in accordance with an embodiment of the present disclosure. The audio interface device 100 includes the body 702 and a head 802. The head 802 corresponds to the first connector 102 (i.e., ¼ inch phone plug or jack). The head 802 may be of various types such as Tip-Sleeve (TS) type head, tip-Ring-Sleeve (TRS) type head, or Tip-Ring-Ring-Sleeve (TRRS) type head. The head 802 is removably inserted into an opening of the instrument 202 for connecting the audio interface device 100 to the instrument 202. The body 702 houses the PCB including the various circuitry and components of the audio interface device 100.

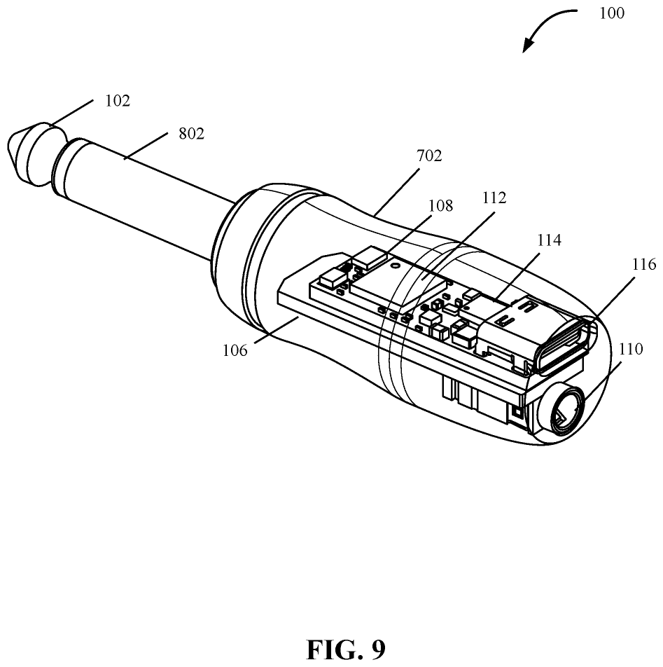

FIG. 9 is a diagram that illustrates various components inside the audio interface device 100, in accordance with an embodiment of the present disclosure. The head 802 of the audio interface device 100 corresponds to the first connector 102. In the context of the present disclosure, the ¼ inch phone plug having ultra-high impedance input) has been used as the first connector 102. The body 702 of the audio interface device 100 houses various components such as the analogue preamplifier 106, the audio codec 108, the third connector 110, the audio controller 112, the USB interface 114, and the USB connector 116. The various components are connected to each other via a communication bus (not shown). The audio interface device 100 facilitates removable USB cable. Further, the digital conversion is executed at the audio source. The various components are housed inside the body of the audio interface device 100 (i.e., an audio connector), without the need of a separate box. The audio interface device 100 facilitates not just TS/TRS (¼ inch) plugs, but also XLR (microphone) interfaces. The audio interface device 100 further facilitates unidirectional as well as bidirectional audio interfaces.

The audio interface device 100 can connect with all types of host devices (such as PC, laptop, mobile devices, or the like). The audio interface device 100 further facilitates all types of wired digital interfaces (such as USB, Lightning, Firewire, Thunderbolt, or the like).

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

We claim:

1. An audio interface device, comprising:
an audio connector including at least one of a ¼ inch phone plug or a 3-pin XLR jack; and
a body having a maximum length of 4 inches connected to the audio connector, wherein the body houses a printed circuit board (PCB) including at least an analogue preamplifier, an audio codec, an audio controller, a Universal Serial Bus (USB) interface, and a USB connector, wherein
the audio codec receives an analog audio signal on the audio connector and performs analog-to-digital conversion, and vice-versa, and
the USB interface interfaces with a host device by using a wireless transceiver or a USB cable connected to the USB connector.

2. The audio interface device of claim 1, wherein the analogue preamplifier the analog audio signal into an output signal that is strong enough to be noise-tolerant and strong enough for further processing by the audio codec and the audio controller.

3. The audio interface device of claim 1, wherein the audio codec includes at least an analog-to-digital converter (ADC) and a digital-to-analog converter (DAC), wherein the ADC converts the analog audio signal into digital audio signals, and wherein the DAC converts the digital audio signals into the analog audio signals.

4. The audio interface device of claim 1 further comprising and a headphone connector, wherein the audio controller controls an input level and an output level of audio signals at the audio connector and the headphone connector, respectively.

5. The audio interface device of claim 1, wherein the body is a generally cylindrical body.

6. The audio interface device of claim 1, wherein the wireless transceiver is connected to a wireless adapter for facilitating connection with the host device.

7. The audio interface device of claim 6, wherein the wireless adapter includes at least a battery, a charging circuitry, a wireless transceiver, and an antenna.

8. The audio interface device of claim 7, wherein the battery is used to power the wireless adapter, and wherein the battery is charged by using the charging circuitry.

9. The audio interface device of claim 1, wherein the wireless transceiver is wirelessly connected to another wireless transceiver of a companion receiver when the host device is without wireless capability, wherein the host device without wireless capability is connected to the companion receiver by using an USB cable.

10. The audio interface device of claim 1, wherein the wireless transceiver is wirelessly connected to another wireless transceiver of the host device with wireless capability for establishing communication between the host device.

11. The audio interface device of claim 1, wherein the body has a maximum length of 3 inches.
